(19) United States
(12) Patent Application Publication
(10) Pub. No.: US 2008/0000136 A1
(43) Pub. Date: Jan. 3, 2008

(54) Method for Production or Pre-Assembly of a Net in Particular a Fishing Net and Fishing Net Obtained Thus

(76) Inventors: Gerard Le Goff, Landela (FR); Jean-Bernard Conte, Plouezec (FR)

Correspondence Address: YOUNG & THOMPSON, 745 SOUTH 23RD STREET, 2ND FLOOR, ARLINGTON, VA, 22202, US

(21) Appl. No.: 11/794,085

(22) PCT Filed: Dec. 22, 2005
(86) PCT No.: PCT/FR05/51132

§ 371 Date: Jun. 25, 2007

(30) Foreign Application Priority Data
Dec. 24, 2004 (FR) 0453222
Jan. 28, 2005 (FR) 0550245

(51) Int. Cl. A01K 71/00

(52) U.S. Cl. 43/7; 29/428

(57) ABSTRACT

The invention relates to a method for production or pre-assembly of a net, in particular a fishing net, comprising at least one fleet (22), connected to at least one mounting thread, itself connected in connector zones to a flotation or sinker line (26), characterized in the use of a mounting thread in the form of a fag end (24) with at least two threads, strands, lines, cables or similar and passing the flotation or sinker line (26) at least once through the threads, strands, lines, cables or similar of the fag end (24) in the connector zones.

The present invention relates to the process for the production or pre-assembly of a net, particularly a fishing net, as well as to a fishing net. The document FR 2.682.261 describes a process to connect layers of fishing nets so as to obtain a so-called “trammel” net.

According to this document, the layers are pre-assembled and interconnected by an adhesive or a textile filament. The upper meshes of this pre-assembly of layers of filament are then threaded on a mounting filament which is itself fixed to a flotation line, also called a bolt rope. In the same way, the lower meshes of this pre-assembly are threaded on a mounting filament which is itself fixed to a sinker line. In the description that follows, for the different figures, there will be described only the upper portion of the net, given that the lower part can be produced in the same way.

Such a mounting requires a large number of working hours. To reduce the costs of production, the makers seek more and more to outsource the greater part of this assembly in areas of low labor cost. However, the mounting on the flotation lines and sinker lines can be carried out only adjacent the boat slips. Thus, the transportation of a net provided with flotation and sinker lines (with it desired a transportation of the lines thus to be provided) is relatively costly and costs more than the assembly, contrary to the layers of net which are light and can be transported from one continent to another with relatively low transportation costs.

Thus, the layers of filaments are pre-mounted in countries with low labor costs. This pre-assembled assembly is then connected to the flotation and sinker lines with the help of a mounting filament.

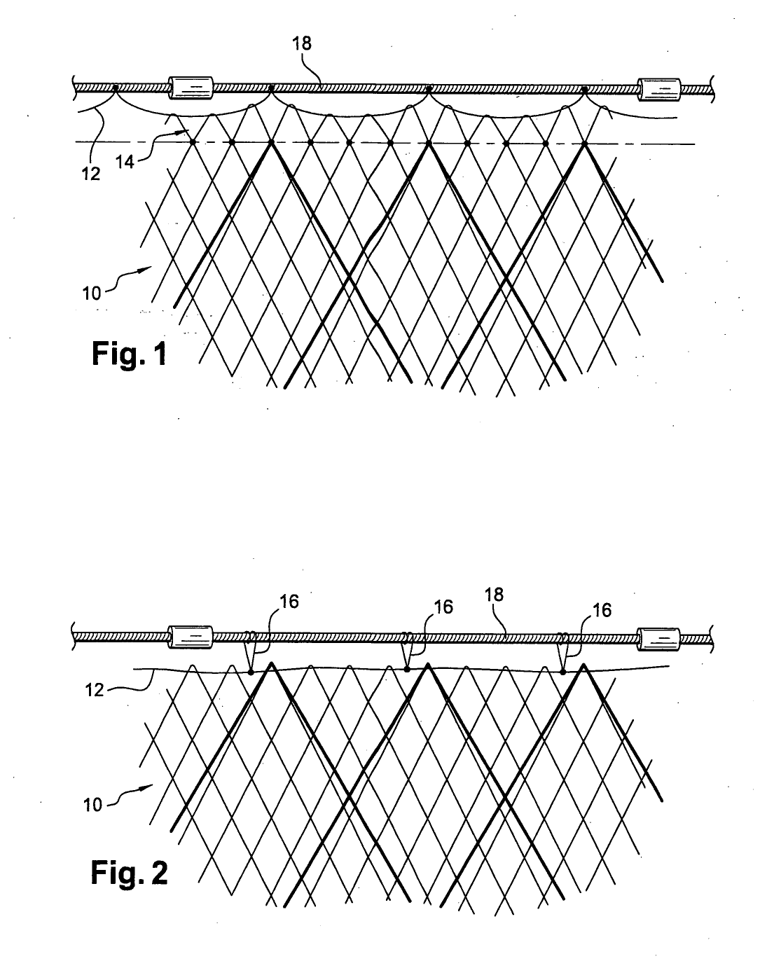

According to a first technique shown in FIG. 1, there is added to the selvedge layers 10 of half-meshes 14 which ensure also the regular and remote assembly of the layers with large meshes with a layer of small meshes. Then, there is introduced a mounting filament 12 through the half-meshes 14. Other techniques could be used to connect the selvedge of the layers 10 to the mounting filament 12.

According to a technique illustrated in FIG. 1, the mounting filament 12 is stitched at regular intervals to the flotation or sinker line 18 while isolating between each stitching point a predetermined number of meshes, in this case four according to the illustrated example, the stitching points being disposed in line with the junctions of the layers of small and large meshes.

Even if this technique permits keeping, during use, the layers distributed in an homogenous manner over all the length of the flotation and sinker lines, it does not give complete satisfaction because the pre-mounting and the mounting on the flotation and/or sinker lines are relatively time consuming and hence costly. As a supplement, this operation of the flotation lines during changing the layers is relatively long and costly.

According to the technique shown in FIG. 2, there are formed loops 16 with the mounting filament 12 to ensure the connection between the mounting filament 12 and the flotation or sinker line 18, with the help of two inverted half-keys. For final assembly, it suffices thus to have loops 16 on a conduit, to pass the line 18 in this conduit and to pull on the flotation or sinker line 18 so as to distribute regularly the loops over all the length. Such an assembly is particularly described in the document WO-03/061374.

The present invention offers an alternative solution by proposing a process of production or pre-assembly of a net, particularly a fishing net, permitting rapidly and simply mounting the layers on the flotation and/or sinker lines so as to reduce costs.

To this end, the invention has for its object a process of production or pre-assembly of a net, particularly a fishing net, comprising at least one layer connected to at least one mounting filament itself connected at zones of connection to a flotation and/or sinker line, characterized in that it consists in using a mounting filament in the form of an end comprising at least two filaments, strands, lines, cables or the like, and causing the flotation and/or sinker line to pass at least once between the filaments, strands, lines, cables or the like of the end at the connection zones.

Other characteristics and advantages will become apparent from the description which follows, of the invention, which description is given only by way of example, with respect to the accompanying drawings, in which:

FIG. 1 is a schematic view showing a first technique for mounting, according to the prior art,

FIG. 2 is a schematic view showing another technique for mounting, according to the prior art,

FIG. 3 is a schematic view showing a pre-assembled assembly according to a first simplified embodiment of the invention, with mounting on a flotation or sinker line,

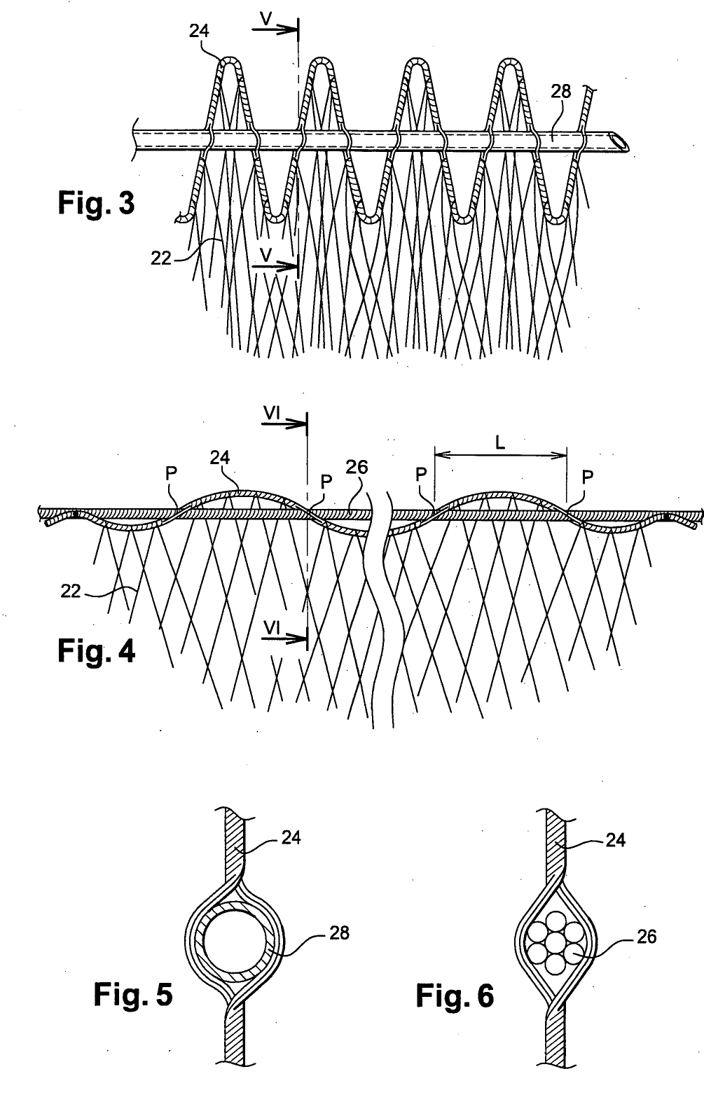

FIG. 4 is a schematic view showing the pre-assembled assembly of FIG. 3 mounted on a flotation or sinker line,

FIG. 5 is a cross sectional view of a portion of the pre-assembled assembly on the line V-V of FIG. 4,

FIG. 6 is a cross section on the line VI-VI of a portion of the net mounted according to a modification of the invention,

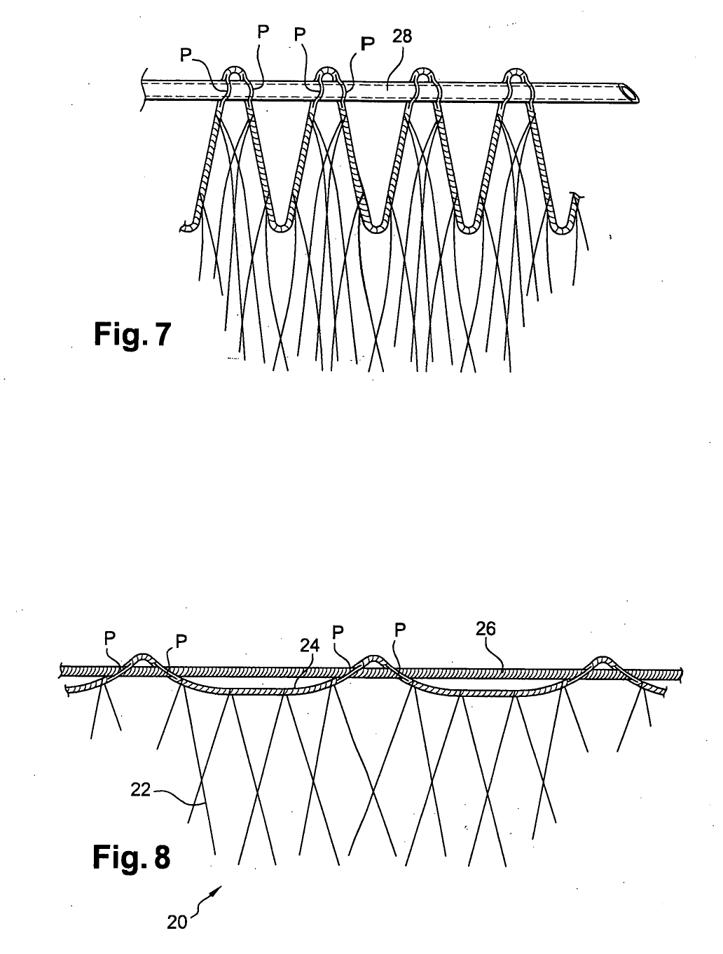

FIG. 7 is a schematic view showing a pre-assembled assembly according to another modification of the invention, before mounting on a flotation or sinker line,

FIG. 8 is a schematic view showing the pre-assembled assembly of FIG. 7 mounted on a flotation or sinker line,

FIG. 9 is a schematic view of layers of net connected with a mounting filament,

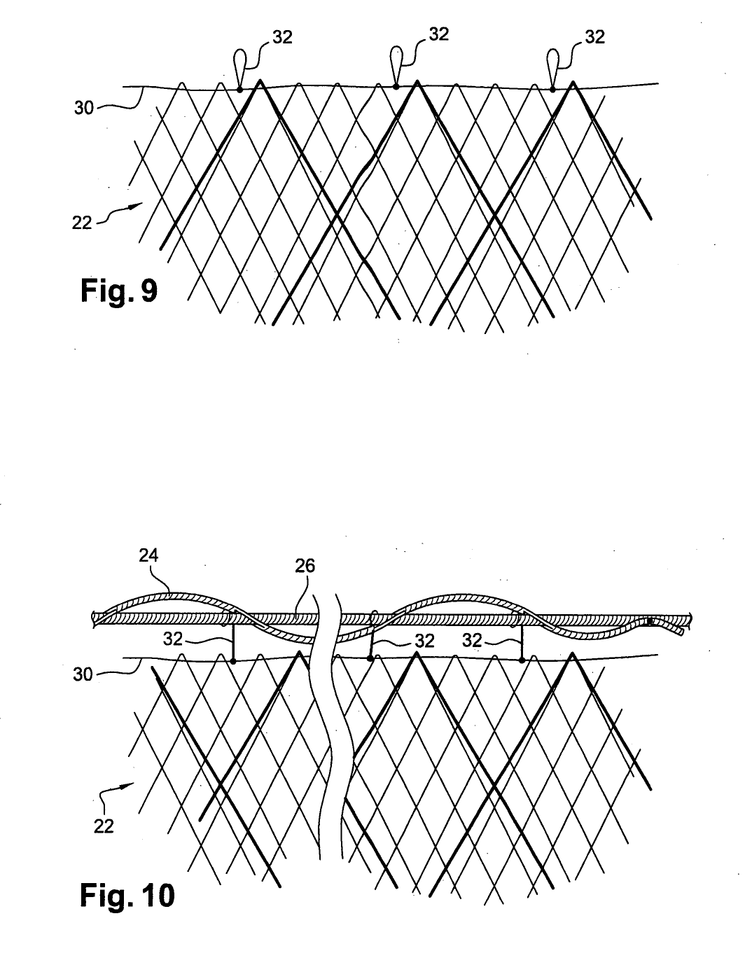

FIG. 10 is a schematic view showing another modification of the invention,

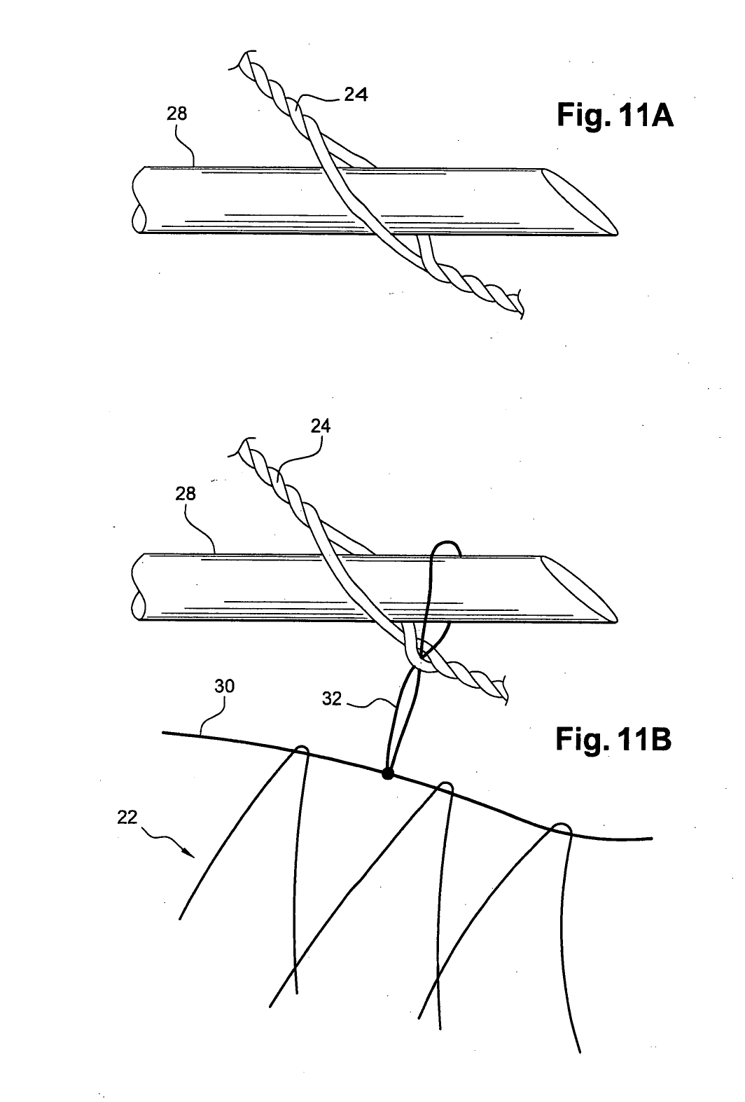

FIG. 11A is a view of details showing a step of mounting of the net of FIG. 10,

FIG. 11B is a view of details showing another step in the mounting of the net of FIG. 10, and

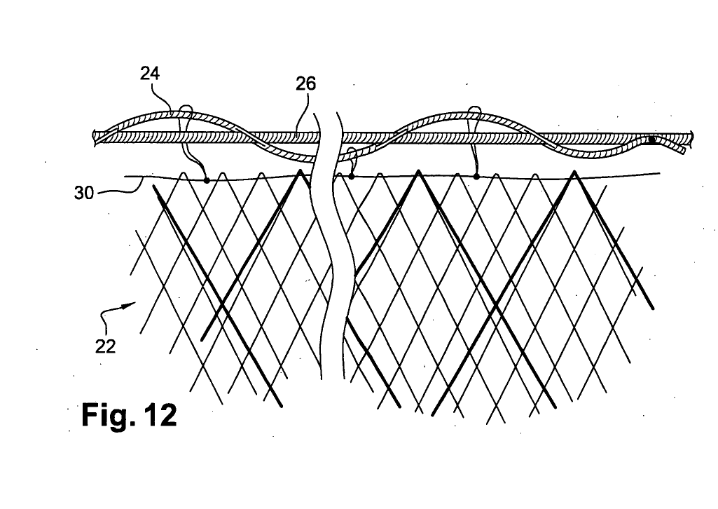

FIG. 12 is a schematic view showing another modification of the invention.

In the different figures, there is shown at 20 a net comprising at least one layer 22. Preferably, the net comprises three layers with different mesh sizes, the embodiment of the layers as well as their shape and nature are not given in greater detail because they are known to those skilled in the art.

The layer or layers 22 are threaded on an end 24 or connected to an end 24. By end, it is meant all types of cordage.

As before, different techniques can be used to ensure the connection between the layer or layers 22 and the end 24. According to modifications, the layer or layers are threaded directly on the end. According to another modification, a half-mesh can be added to the layers, as shown in FIG. 1. As a modification, the layer or layers could be threaded on a mounting filament, which is itself fixed to the end 24 by any appropriate means, as shown in FIG. 10. The connection between the layer or layers and the end is not given in greater detail because it is known to those skilled in the art.

This pre-assembly of the end and the layers is preferably carried out in countries with low labor costs.

To complete the mounting of the net, this pre-assemblage must be connected to at least one flotation and/or sinker line 26. In what follows of the description, only the connection between the pre-assembly and the flotation line will be described. As the case may be, there can be used this type of connection or another one, to connect the pre-assembly and the sinker line (not shown in the drawings).

According to the invention, the end 24 used for pre-assembly is a twisted end comprising at least strands. Preferably, there is used a pairwise twisted end (2-4-6).

To connect the pre-assembly to the flotation line 26, this latter is introduced between the strands of the end 24 as shown in FIG. 6. This point of passage of the flotation line 26 between the strands of the end 24 forms a connection zone between said line 26 and said end 24. Preferably, the connection zones permit isolating a predetermined number of meshes so as to obtain a homogeneous distribution of the layers over the length of the lines 26.

According to a first simplified modification, the flotation line 26 passes between strands at substantially regular intervals, as shown in FIGS. 3 and 4. According to one embodiment, the twisted end 24 is threaded on a tube 28, the loops formed between the points of passage of the flotation line between the strands of the end 24 having a length L. In FIG. 5, there is shown in cross section the twisted end 24 threaded on the tube 28.

Thereafter, the flotation line 26 is introduced into the tube 28. Finally, the tube 28 is removed.

Preferably, after introduction of the flotation line 26 into the tube 28, the end 24 and/or the line 26 are pulled on, which can be preferably connected by any suitable means, for example by stitching so as to transfer the points of passage onto the flotation or sinker line 26.

There is thus obtained a net as illustrated in FIG. 4. The end 24 extends over all the length of the flotation line 26, the zones of connection between the end and the flotation line, corresponding to the points of passage P of the flotation line between the strands of the end, being separated by a distance substantially equal to L. The friction between the flotation line and the strands at the end permit limiting the risk of sliding of the end on the flotation line, which permits preserving a good distribution of the layer or layers along the flotation line. It will be noted that the layers are blocked on the flotation or sinker line 26 when the end 24 and said line are connected on opposite sides of the layers, the end 24 having a length slightly greater than the line 26.

According to another embodiment shown in FIGS. 7 and 8, the connection zones between the flotation line 26 and the end 24 are separated as before, by a distance L, each connection zone comprising at least two spaced points of passage P. This arrangement permits further reducing the risk of sliding of the end on the flotation line.

As before, the introduction of the flotation line between the strands of the end can be carried out by using a tube 28 as shown in FIG. 7.

However, other solutions could be envisaged to thread the flotation line between the strands of the end 24, for example a needle.

According to the invention, there is obtained a rapid and simple mounting of the flotation and sinker lines, which contributes to reducing the costs.

According to modifications, the mounting of the end 24 on the tube 28 can be carried out in a region of low labor cost. In this case, the pre-assembly comprises the layer or layers, the twisted end or ends (one for the flotation line and/or one for the sinker line) and a tube for each end to permit threading the flotation and/or sinker line.

According to another advantage obtained by the invention, the disassembly of the flotation or sinker line is very rapid and simple, because it suffices to slide the end 24 on said line.

In FIGS. 9, 10, 11A and 11B, there is shown another modification of the invention.

In this case, the layer or layers 22 are threaded on a mounting filament 30. Loops 32 are produced in the mounting strand, permitting separating a predetermined number of meshes, for example four small meshes and one large mesh.

According to this embodiment, the flotation line 26 is introduced between the strands of the end 24 and the loops 32 of the mounting filament passing between the strands of the end 24 adjacent the passage point of the flotation line 26 and are threaded on the flotation line 26.

Preferably, for assembly, there is used as before a tube 28, as shown in FIGS. 11A and 11B. In a first phase, the tube passes between the strands of the end 24 as shown in FIG. 11A. Preliminary to this passage, or just afterward, a loop 32 passes between the strands of the end 24 leaving preferably one strand between the passage point of the tube 28 and the passage point of the loop 32, then the loop 32 is threaded on the tube 28, as shown in FIG. 11B. The steps illustrated in FIGS. 11A and 11B are thus repeated.

As before, the mounting of the end 24 on the tube 28 can be carried out in a region of low labor cost.

To achieve the mounting of the net, the flotation line 26 is introduced into the tube 28. Finally, the tube 28 is removed.

This modification permits obtaining a net mounting with topping lifts. According to this modification, the anchoring points of the layers on the flotation or sinker line are completely immobile.

As a modification, as shown in FIG. 12, the loops 32 are threaded on the end 24, the flotation line 26 being introduced between the strands of the end 24 while isolating between each passage a predetermined number of loops 32, in this case one loop.

Of course, the invention is clearly not limited to the embodiment shown and described above, but on the contrary covers all the modifications, particularly as to the nature and shape of the different elements constituting the net which can comprise one or several layers.

Moreover, the end 24 need not be stranded. The end 24 is an assembly of at least two filaments, strands, cables or the like which can be twisted, woven, interlaced, intercrossed, molded or the like. Moreover, these twists, filaments, strands, cables or the like can be made from different materials.

Finally, the mounted net according to the invention could be used in other fields than fishing.

1. Process for the production or pre-assembly of a net, particularly a fishing net, comprising at least one layer (22) connected to at least one mounting filament itself connected to at connection zones to a flotation and/or sinker line (26), characterized in that it consists in using a mounting filament in the form of an end (24) comprising at least two filaments, strands, lines, cables or the like that are assembled, and in passing the flotation and/or sinker line (26) at least once between the filaments, strands, lines, cables or the like of the end (24) at the connection zones.

2. Process for the production or pre-assembly of a net according to claim 1, characterized in that the connection zones are separated by a substantially constant distance and isolate a predetermined number of meshes.

3. Process for the production or pre-assembly of a net according to claim 1, characterized in that it consists in passing the flotation line (26) between the filaments, strands, lines, cables or the like of the end (24) at least two points of the passage P at the connection zones.

4. Process for the production or pre-assembly of a net according to claim 1, characterized in that it consists in threading the end (24) on a tube (28) by causing said tube to pass between the filaments, strands, lines, cables or the like of the end at least once in the connection zones, in introducing the flotation or sinker line (26) into the tube (28).

5. Process for the production or pre-assembly of a net according to claim 4, characterized in that after introduction of the flotation or sinker line (26) into the tube (28), one pulls on the end (24) and/or on the line (26) which can if desired be connected, so as to transfer the passage points to the flotation or sinker line (26).

6. Net obtained by the process according to claim 1, said net comprising at least one layer (22) connected to at least one mounting filament itself connected in connection zones to the flotation and/or sinker line (26), characterized in that the mounting filament is an end (24) comprising at least two filaments, strands, lines, cables or the like and in that the flotation and/or sinker line (26) passes at least once between the filaments, strands, lines, cables or the like of the end (24) in the connection zones.

7. Net according to claim 6, characterized in that for each connection zone between the end (24) and the flotation or sinker line (26), said line (26) passes between the filaments, strands, lines, cables or the like of the end (24) and at least two passage points P.

8. Fishing net according to claim 6, characterized in that the connection zones are separated by a substantially constant distance and isolate a predetermined number of meshes.

9. Pre-assembly used for the mounting of a net according to claim 6, said pre-assembly comprising at least one layer (22), characterized in that it comprises at least one end (24) with at least two filaments, strands, lines, cables or the like and at least one tube (28) on which is threaded the end (24) by causing said tube (28) to pass between the filaments, strands, lines, cables or the like of the end at least once in the connection zones.

10. Process for the production or pre-assembly of a net according to claim 2, characterized in that it consists in passing the flotation line (26) between the filaments, strands, lines, cables or the like of the end (24) at least two points of the passage P at the connection zones.

11. Process for the production or pre-assembly of a net according to claim 2, characterized in that it consists in threading the end (24) on a tube (28) by causing said tube to pass between the filaments, strands, lines, cables or the like of the end at least once in the connection zones, in introducing the flotation or sinker line (26) into the tube (28).

12. Process for the production or pre-assembly of a net according to claim 3, characterized in that it consists in threading the end (24) on a tube (28) by causing said tube to pass between the filaments, strands, lines, cables or the like of the end at least once in the connection zones, in introducing the flotation or sinker line (26) into the tube (28).

13. Net obtained by the process according to claim 2, said net comprising at least one layer (22) connected to at least one mounting filament itself connected in connection zones to the flotation and/or sinker line (26), characterized in that the mounting filament is an end (24) comprising at least two filaments, strands, lines, cables or the like and in that the flotation and/or sinker line (26) passes at least once between the filaments, strands, lines, cables or the like of the end (24) in the connection zones.

14. Net obtained by the process according to claim 3, said net comprising at least one layer (22) connected to at least one mounting filament itself connected in connection zones to the flotation and/or sinker line (26), characterized in that the mounting filament is an end (24) comprising at least two filaments, strands, lines, cables or the like and in that the flotation and/or sinker line (26) passes at least once between the filaments, strands, lines, cables or the like of the end (24) in the connection zones.

15. Net obtained by the process according to claim 4, said net comprising at least one layer (22) connected to at least one mounting filament itself connected in connection zones to the flotation and/or sinker line (26), characterized in that the mounting filament is an end (24) comprising at least two filaments, strands, lines, cables or the like and in that the flotation and/or sinker line (26) passes at least once between the filaments, strands, lines, cables or the like of the end (24) in the connection zones.

16. Net obtained by the process according to claim 5, said net comprising at least one layer (22) connected to at least one mounting filament itself connected in connection zones to the flotation and/or sinker line (26), characterized in that the mounting filament is an end (24) comprising at least two filaments, strands, lines, cables or the like and in that the flotation and/or sinker line (26) passes at least once between the filaments, strands, lines, cables or the like of the end (24) in the connection zones.

17. Fishing net according to claim 7, characterized in that the connection zones are separated by a substantially constant distance and isolate a predetermined number of meshes.

18. Pre-assembly used for the mounting of a net according to claim 7, said pre-assembly comprising at least one layer (22), characterized in that it comprises at least one end (24) with at least two filaments, strands, lines, cables or the like and at least one tube (28) on which is threaded the end (24) by causing said tube (28) to pass between the filaments, strands, lines, cables or the like of the end at least once in the connection zones.

19. Pre-assembly used for the mounting of a net according to claim 8, said pre-assembly comprising at least one layer (22), characterized in that it comprises at least one end (24) with at least two filaments, strands, lines, cables or the like and at least one tube (28) on which is threaded the end (24) by causing said tube (28) to pass between the filaments, strands, lines, cables or the like of the end at least once in the connection zones.
